(19) United States
(12) Patent Application Publication
(10) Pub. No.: US 2003/0109589 A1
(43) Pub. Date: Jun. 12, 2003

(54) Aqueous colloidal dispersion based on at least a metal compound and a complexing agent, preparation method and use

(76) Inventor: Jean-Yves Chane-Ching, Eaubonne (FR)

Correspondence Address: BURNS DOANE SWECKER & MATHIS L L P, POST OFFICE BOX 1404, ALEXANDRIA, VA, 22313-1404, US

(21) Appl. No.: 10/169,194

(22) PCT Filed: Dec. 29, 2000
(86) PCT No.: PCT/FR00/03755

(30) Foreign Application Priority Data
Dec. 30, 1999 (FR) 9916786

(51) Int. Cl. C09K 3/00

(52) U.S. Cl. 516/53

(57) ABSTRACT

The invention concerns an aqueous colloidal dispersion of the aqueous colloidal nanometric type wherein the mean colloidal particle diameter is not more than 6 nm, said dispersion comprising: (1) at least a metal M compound, said metal M being a majority metal in the dispersion, selected among the group consisting of aluminium, zirconium and metals or the periodic table whereof the atomic number is between 22 and 31; and (2) at least a complexing agent having a pKₛ(M) (cologarithm of the dissociation constant of the complex formed by the complexing agent and the cation of said metal M) more than 2. The invention also concerns the method for preparing said dispersion. The resulting dispersion can in particular be used for preparing anti-UV filters, in catalysis, or as reinforcement of polymeric or mineral matrices.

The present invention relates to aqueous colloidal dispersions based on at least one compound of a metal and a complexing agent. It also relates to the preparation process and the uses of such dispersions.

Colloidal dispersions (or sols) of oxides and/or hydrated oxides (hydroxides) of a metallic nature and in particular zirconium dioxide or titanium dioxide sols are well known to the skilled person and their obtention methods have also been widely described in the prior art. With regards to zirconium dioxide sols, reference can e.g. be made to Journal of Gel Science Technology, vol. 1, p 223 (1994). Reference can also be made to the article in Chemical Materials, vol. 10, pp 3217-3223 (1998) in connection with titanium dioxide sols.

It should also be noted that as a function of the nature of the metallic element used, said suspensions can have a great interest for applications in the catalysis field or in the anti-UV protection field. However, it must be stressed that for such applications, particularly in order to increase the specific surface of the colloids or obtain transparent suspensions, there is a need for so-called “nanometric” sols comprising extremely fine colloids and advantageously having dimensions of a few nanometres to a few tens of nanometres.

However, it is often difficult to obtain such sols. Thus, rapid particle formation kinetics often occurs, which render difficult to stopp the mineral polycondensation at the nanometric particle stage. Thus, in the general case, particles of an excessive size are ultimately obtained, which have a marked tendency to settle.

The object of the invention is to solve such problems and to obtain stable sols comprising colloids with nanometric dimensions.

More specifically, the present invention relates to an aqueous colloidal dispersion wherein the mean diameter of the colloidal particles is at the most of 6 nm, said dispersion comprising:

(1) at least one compound of a metal M, said metal M being a majority metal within the dispersion, which is chosen from the group constituted by aluminium, zirconium and metals of the periodic table whose atomic number is between 22 and 31; and

(2) at least one complexing agent having a Pks(M) (cologarithm of the constant of dissociation of the complex formed by the complexing agent and the cation of said metal M) of more than 2.

In particularly preferred manner, said metal M is chosen from aluminium, titanium, iron and zirconium.

The invention also relates to a process for the preparation of the aforementioned dispersions and which is characterized in that it comprises the steps consisting of:

(a) forming an aqueous mixture comprising at least one salt of said metal M and at least one complexing agent,;

(b) adding a base to the mixture formed in that way; and

(c) heating the mixture formed in that way.

Other features, details and advantages of the invention will be more clearly gathered from the following description, as well as the various specific, and non-limitative examples intended to illustrate the same.

The periodic table of elements to which the present description refers is that published in the supplement to the Bulletin of the Chemical Society of France, no. 1, January 1966.

The term “lanthanide” is understood to mean elements of the group constituted by yttrium and elements of the periodic table with an atomic number between 57 and 71 inclusive.

In the sense of the present invention, a colloidal dispersion (or sol) of a compound of a metal M, or of a metal M and one or more element(s) of the aforementioned types, designates any system constituted by fine solid particles having colloidal dimensions, generally based on an oxide and/or hydrated oxide (hydroxide) of the metal M, or, if appropriate, oxide and/or hydrated oxide (hydroxide) of the metal and said other element(s), and, optionally, on complexing agent, suspended in an aqueous liquid phase, wherein said species can optionally also contain residual quantities of linked or adsorbed ions, such as e.g. chloride ions, nitrate ions, acetate ions, citrate ions, ammonium ions, or complexing agent in ionized form. It should also be noted that, in such dispersions, the metal M and the other element(s) can either be totally in the form of colloids, or simultaneously in the form of ions, of complexed ions, and in the form of colloids.

The dispersions according to the invention are specifically dispersions wherein the metal M is a metal present in a majority quantity. Thus, according to a first embodiment, it is possible to have dispersions solely based on one or more compound(s) of the metal M, but according to a specific embodiment, dispersions according to the invention may also comprise, further to one or more compound(s) of the metal M, one or more compounds of one or more additional metallic element(s) other than the metal M and chosen from lanthanides, aluminium and elements of groups IVa, Va, VIa, VIIa, VIII, Ib and IIb of the periodic table. However, according to this special embodiment, the metal M specifically remains in a majority within the dispersion, i.e. the molar ratio (metal M)/(metal M+other metallic element(s)) is always at least equal to 50%, it being understood that said ratio strictly exceeds 50% in the specific case of the presence of a compound of a lanthanide.

Thus, and especially in the case of the additional presence of at least one compound of a lanthanide, the molar ratio (metal M)/(metal M+other elements) generally remains strictly above 50%. According to this special embodiment, said molar ratio can advantageously exceed 60% and in particular 70%. Said ratio may in particular exceed 80% or 90%.

Among lanthanides especially appropriate for this embodiment of the invention, reference can more particularly be made to yttrium, cerium, lanthanum, neodymium, gadolinium and samarium.

As an element of group IVa, reference can more particular be made to titanium and zirconium.

As an element of group Va, reference can be made to vanadium.

Chromium and molybdenum can be more particularly chosen as elements of group VIa, and manganese for group VIIa.

As the element of group VIII, use is advantageously made of iron, cobalt and nickel. In said same group, reference can also be made to precious metals such as platinum, iridium, ruthenium, rhodium and palladium.

Copper, silver and gold on the one hand and zinc on the other can be chosen with regards to groups Ib and IIb respectively.

Thus, particularly advantageous dispersions in said embodiment are those based on a combination of aluminium and zinc, of aluminium and titanium, of titanium and palladium, of iron and titanium and of zirconium and cerium.

According to a specific aspect, the invention also relates to so-called “stoichiometric” dispersions. These specific dispersions are based on a metal M, and on a single additional metallic element A chosen from among one of the aforementioned metallic elements with the exception of a lanthanide, namely aluminium and elements of groups IVa, Va, VIa, VIIa, VIII, Ib and IIb of the periodic table and are specifically characterized by a molar ratio M/(M+A), which, in this precise case, is equal to 50%.

As a dispersion according to this special embodiment, reference can e.g. be made to “FeTiO3” dispersions, based on iron oxide FeO and titanium dioxide TiO2, in an equimolar ratio.

No matter what the precise chemical nature of the metallic compounds present within the dispersions according to the invention, it must be stressed that these dispersions are specifically those in which, for more than 50% of the colloids, the mean diameter is at the most 6 nm. More particularly, said mean diameter is below 5 nm and can in particular be between 2 and 5 nm.

The aforementioned diameters can in particular be determined by photometric counting based on an analysis by HRTEM (high resolution transmission electron microscopy), supplemented if necessary by cryomicroscopy.

Apart from their small size, the colloids of the dispersions according to the invention also have a relatively low aggregation level. Analyses by transmission electron microscopy reveal low colloid aggregate levels, in general below 10% or even 5%, i.e. with respect to all the objects observed, in general at the most 10% are constituted by several aggregated particles.

Within the terms of the present invention, “complexing agent” designates a compound or molecule able to establish a covalent or ionocovalent bond the metal cation and/or the cation or cations of the other element or elements. The complexing agents of the present invention are those for which the dissociation constant or constants of the complexing agent or agents formed with the metal ion or ions present are low (stable complexes). The complexes considered here are those formed by the complexing agent or agents and the metal cation and, if appropriate, the complex or complexes formed by the complexing agent and the aforementioned supplementary element or elements.

As an example, for the equilibrium given hereinafter (complexing of a cation of metal M):

Complex Ks cation of metal M+complexing agent,

-----→

←--

the dissociation constant Ks(M) of the complex is given by the formula:

(M)=[cation of metal M]×[complexing agent]/[complex]

The pKs(M) is the cologarithm of Ks(M), defined by pKs(M)=−logKs(M). This value is dependent both on the nature of the metal cation and on the nature of the complexing agent and reflects the stability of the complex formed by these two species. In other words, the more stable the complex, the higher the value of pKs(M).

The complexing agent(s) used in the present invention have pKs values above 2, and preferably of at least 3, with respect to the different metal cations with which they form one or more complexes.

Thus, the nature of the complexing agent used has to be adapted as a function of the nature of the metal M and the optionally present other element or elements.

However, it should be noted that in general terms, the complexing agent can be advantageously chosen from among acid-alcohols, or polyacid-alcohols or salts of these compounds. As an example of a particularly suitable acid-alcohol, reference can be made to glycolic acid or lactic acid. As a polyacid-alcohol, reference can be made to malic acid and citric acid.

The complexing agent can also be advantageously chosen from among aliphatic amino acids and preferably aliphatic amino polyacids or their salts. Examples of such complexing agents are ethylene-diamine-tetraacetic acid or nitrilo-triacetic acid or the sodium salt of N, N diacetic glutamic acid of formula (NaOOC)CH2CH2-CH(COONa)N(CH2COONa)2.

Other suitable complexing agents are polyacrylic acids or their salts, such as sodium polyacrylate and more specifically those having a molecular weight between 2000 and 5000.

It should finally be noted that, according to the invention, one or more complexing agents can be present in the same dispersion.

The level of complexing agent present within the suspensions according to the invention is determined by chemical dosing of carbon and metal M present in the colloidal dispersion. This level is expressed as the number of moles of complexing agent relative to the total number of moles of metal M and advantageously varies between 0.1 and 2 and in particularly preferred manner between 0.1 and 1.5.

The level of complexing agent present in the colloids is determined by chemical dosing of carbon and metal M present in the centrifuging deposit obtained by ultracentrifuging the dispersion at 50,000 revolutions per minute for 6 hours. This level of complexing agent within the colloids, also expressed as a number of moles of complexing agent based on the number of moles of metal M, is advantageously between 0.1 and 2 and preferably between 0.2 and 1.

The calculation of these levels applies to the sum of the complexing agents if several complexing agents are present in the dispersion, and to the sum of the different metallic elements present if one or more supplementary elements are present in addition to the metal M.

The dispersions according to the invention can have pH values in an extensive range, particularly between 3 and 10 and advantageously between 7 and 9, which permits their use in applications where a pH close to neutrality is required.

The concentrations of the dispersions according to the invention are at least 0.1 mole/l. They can advantageously be at least 0.5 mole/l or even exceed 1 mole/l. These concentrations are expressed as the concentration of the metal M or, if appropriate, as the concentration of the metal M and the aforementioned element or elements. This concentration is determined after drying and calcination in air of a given dispersion volume.

The procedure for preparing dispersions according to the invention will now be described.

The first step (a) of the preparation process consists of forming an aqueous mixture comprising at least one salt of the metal M and the complexing agent. This mixture can optionally also comprise at least one salt of one or more elements of the groups referred to hereinbefore in the case of the preparation of dispersions based on at least one of these elements.

According to another embodiment, it is also possible in this case to prepare on the one hand a first mixture with at least one salt of the metal M and a first complexing agent and on the other one or more other mixtures, each comprising one or more salts of the additional, potential metallic elements referred to and the same complexing agent, or a complexing agent different from that used in the first mixture.

The salts can be organic or inorganic acid salts, e.g. of the sulphate, nitrate, chloride or acetate type. It should be noted that chloride, nitrates and acetates are particularly suitable. As the titanium, iron, aluminium or zirconium salt, it is more particularly possible to use TiOCl2, Fe(NO3)3, Al(NO3)3 and ZrO(NO3)2.

In the starting mixture(s), the molar content of complexing agent based on the salt or salts introduced is preferably between 0.1 and 3 and advantageously between 0.25 and 2.

The second step (b) of the process consists of increasing the pH value of the mixture(s) prepared during stage (a).Therefore, a base is added thereto. A particularly suitable base is constituted by alkali metal or alkaline earth hydroxides and ammonia. It is also possible to use secondary or tertiary amines. However, amines and ammonia can be preferred to the extent that these compounds avoid pollution risks by alkali metal or alkaline earth cations.

The base is added until a pH is obtained, whose value varies as a function of the nature of the metal M and, eventually, of the element(s) used, and of the nature and content of the complexing agent. It should be noted that the higher the complexing agent content the lower the pH value. The base is generally added until a pH value is obtained for which there is the start of dissolving of the precipitate formed in the first part of the addition stage. In the case of the particular implementation described hereinbefore and in which two or more starting mixtures were prepared, a base is added to each of the different mixtures in a separate way and then these mixtures are combined, adjusting the pH if necessary.

The third step (c) of the process is a heat treatment, also called thermohydrolysis, which consists of heating the mixture obtained at the end of stage (b). The heating temperature is generally at least 60øC and preferably at least 100øC and can rise to the critical temperature of the reaction medium.

Depending on the temperature conditions implemented, this heat treatment can be performed either under normal atmospheric pressure, or under a pressure such as e.g. saturated steam pressure corresponding to the heat treatment temperature. When the treatment temperature is chosen above the reflex temperature of the reaction mixture (i.e. generally 100øC), then generally the operation is carried out by introducing the aqueous mixture into a closed container (sealed reactor, normally called an autoclave), the necessary pressure then only resulting from the heating of the reaction medium (autogenic pressure). Under the temperature conditions given hereinbefore and in an aqueous medium, for illustration purposes, it can be stated that the pressure in the sealed reactor varies between a value higher than 1 bar (105 Pa) and 165 bar (165ú105 Pa) and preferably between 1 bar (105 Pa) and 20 bar (20u105 Pa). It is obviously also possible to exert an external pressure, which is then added to that resulting from the heating.

Heating can either take place under an atmosphere of air, or under an inert gas atmosphere and preferably in this case under a nitrogen atmosphere.

The duration of the treatment is not critical and can consequently vary widely, advantageously between 1 and 48 hours and preferably between 2 and 24 hours.

At the end of the treatment a dispersion according to the invention is obtained.

According to a variant of the invention, the dispersion obtained at the end of step (c) can be treated by ultrafiltration, particularly so as to purify and concentrate the dispersion obtained at the end of stage (c). This treatment can take place immediately after stage (c) or at a later time.

If appropriate, ultrafiltration can take place under air or an atmosphere of air and nitrogen or under nitrogen. It preferably takes place with water, whose pH is adjusted to the pH of the dispersion.

The suspensions according to the invention can also undergo other concentration stages and in particular concentration by evaporation. The evaporation temperature is then defined in such a way as to avoid flocculation of the colloidal dispersion. For information purposes, said temperature is generally between 20 and 90øC and advantageously between 20 and 60øC.

There are numerous applications for the dispersions according to the invention. Reference can e.g. be made to catalysis, particularly for transesterification or polycondensation reactions, e.g. for polyethylene terephthalate production, or for the amidification reaction, particularly for polyamide synthesis. In this case, the dispersions are used in the preparation of catalysts. The dispersions can also be implemented for their anti-UV properties, e.g. in the preparation of polymer protective films (e.g. of the acrylic or polycarbonate type) or cosmetic compositions, particularly in the preparation of anti-UV creams. Finally, they can be used for reinforcing polymer or mineral matrixes.

Examples will now be given.

### EXAMPLE 1

This example relates to the preparation of a colloidal dispersion based on an aluminium compound according to the invention.

(a) Into a beaker are introduced 112.5 g (or 0.3 mole) of Al(NO3)3 9 H₂O (M=375 g/mole) and 31.5 g (or 0.15 mole) or citric acid monohydrate (M=210.14 g/mole). This is followed by addition of 120 g of demineralized water. The mixture obtained is then stirred at a temperature of 25øC, so as to obtain a solution with a total volume of 200 ml with a complexing agent/aluminium molar ratio of 0.5.

(b) This is followed by the addition to this solution stirred at 25øC of a previously dosed 10 M ammonium solution kept in a sealed atmosphere so as to minimize evaporation thereof. This addition takes place with the aid of a dosing pump and a controlled flow rate of 0.5 ml/minute. During this ammonia addition, a white, opaque dispersion is formed. When a clarification of said suspension is noted, i.e. after 3 hours 45 minutes, addition is stopped. The total added ammonia volume at this time is 111.5 ml and the pH value of the dispersion 8.3.

(c) The obtained dispersion is then immediately transferred into a Parr cylinder. This Parr cylinder is placed in an oven previously heated to 120øC and the dispersion undergoes a heat treatment at 120øC for 14 hours, the Parr cylinder serving as an autoclave.

After cooling, 120 ml of the obtained aluminium oxy-hydroxide dispersion undergo an ultrafiltration. For this purpose, 240 ml of demineralized water are added to 120 ml of the dispersion obtained after heat treatment. The suspension obtained is ultrafiltered on a 3 KD membrane until a dispersion volume of 120 ml is obtained. This operation is repeated twice, noting that the ultrafiltration of the final operation continues up to a final dispersion volume of 60 ml instead of 120 ml.

The equivalent Al2O3 content determined by heating in an oven and calcining at a temperature of 900øC of an aliquot part of the dispersion is 5.24 wt. %. The aluminium concentration in the dispersion obtained after ultrafiltration is 1.03 mole/l.

By transmission cryomicroscopy on the sample and without dilution, it is possible to observe perfectly individualized nanometric size particles, whose mean size is 3 nm.

The dispersion obtained is stable with respect to settling over a period exceeding 6 months.

### EXAMPLE 2

This example relates to a colloidal dispersion with a neutral pH, based on a titanium compound.

(a) Into a beaker are introduced 16.7 g of citric acid (M=192 g/mole). This is followed by the addition of 404 g of demineralized water and then, accompanied by stirring and in instantaneous manner, 78 g of a TiOCl2, 2 HCl solution with a titanium content of 4.95 mole/l, i.e. 3.19 mole/kg, so as to obtain a solution which is clear to the naked eye and characterized by a complexing agent/titanium molar ratio of 0.35.

(b) To solution stirred at a temperature of 25øC are then added 100 ml of a 10M ammonia solution using a dosing pump having a constant flow rate of 0.6 ml/mn. During said ammonia addition, a precipitate is formed, followed by a white opaque dispersion. At the end of addition, i.e. after 2 hours 45 minutes, a dispersion is obtained which is characterized by a 0.45 mole/litre titanium content.

(c) The obtained dispersion is then transferred into a Parr cylinder. Said Parr cylinder is placed in an oven previously heated to 90øC. The dispersion then undergoes a heat treatment at 90øC for 14 hours, the Parr cylinder serving as an autoclave.

After cooling, 120 ml of the thus obtained TiO2 dispersion under ultrafiltration. For this purpose 240 ml of demineralized water are added to the 120 ml of dispersion obtained after the heat treatment. The suspension obtained undergoes ultrafiltration on a 3 KD membrane until a dispersion volume of 120 ml is obtained. This operation is repeated twice and in the ultrafiltration of the final operation the final dispersion volume is 60 ml and not 120 ml. A dispersion with a pH of 6.5 is then obtained.

Dosing by calcination of an aliquot part shows that said dispersion has a 6 wt. % TiO2 concentration after ultrafiltration.

A final concentration of the colloidal solution then takes place by evaporation. 55 ml of the colloidal TiO2 dispersion obtained at the end of the ultrafiltration stage are introduced into a diameter 7 cm, height 4 cm crystallizer and undergoes evaporation at 50øC for 6 hours. The TiO2 concentration of the dispersion from said evaporation stage is 12.3 wt. %, i.e. 1.53 mole/litre of titanium.

By transmission electron cryomicroscopy on the sample diluted to a 2 wt. % TiO2 concentration, it is possible to observe TiO2 particles with nanometric dimensions with an average size of 3 nm.

The dispersion is stable with respect to settling over a period exceeding 6 months.

### EXAMPLE 3

This example relates to a colloidal dispersion based on a titanium compound and a cerium compound.

(a) Into a beaker are introduced 13.68 g of solid CeCl3 (with an equivalent CeO2 content of 45.8%, determined by calcining at 1000øC for 1 hour), followed by 250 ml of demineralized water. After stirring and dissolving the salt, 46 ml of a 3.5 mole/l TiOCl2, 2HCl solution are added. The solution volume is topped up with 500 ml of demineralized water. To an aliquot part of 400 ml are added 11.6 g of citric acid (M=192 g/mole), so as to obtain a solution characterized by a molar ratio (Ti/Ce) of 4.4:1, i.e. a molar ratio Ti/(Ti+Ce) of 81% and a molar ratio of complexing agent/(Ti+Ce) of 0.38.

(b) Using a dosing pump with a controlled flow rate of 3 ml/mn, 97.4 g of a 9.96 M ammonia solution are then added to said solution, whereof stirring is maintained at a temperature of 25° C.

(c) The obtained suspension is transferred into a Parr cylinder. Said Parr cylinder is placed in an oven previously heated to 120øC. Heat treatment of the dispersion is carried out for 16 hours at 120øC, the Parr cylinder serving as an autoclave.

The dispersion obtained is allowed to cool to ambient temperature. The pH value of the dispersion obtained is 8.8.

Using transmission cryomicroscopy, it is possible to observe perfectly individualized nanometric size particles with an average size of 3 nm.

A 27 g aliquot part of the dispersion obtained undergoes ultracentrifuging at 50,000 r.p.m. for 6 hours. The deposit (2.0 g) and supernatant phase (24.94 g) are separated. By chemical dosing of the titanium and cerium, the molar ratio (Ti/Ce) is 5.6:1 in the deposit and there are 92% (Ti+Ce) in colloidal form in the dispersion. By dosing the carbon, a citrate/Ti+Ce) molar percentage of 0.20 is determined in the colloids.

### EXAMPLE 4

This example relates to a colloidal dispersion based on an iron compound.

(a) Into a beaker are introduced 20.2 g of Fe(NO3)3, x H₂O (M=404 g/mole) and 19.2 g of citric acid (M=192 g/mole). The volume is then adjusted to 100 ml with demineralized water. The mixture obtained is then stirred at 25øC, so as to obtain a solution with a total volume of 200 ml and with a (complexing agent/Fe) molar ratio of 2.

(b) Using a dosing pump at a rate of 3 ml/mn a 10 M ammonia solution is added to said solution, whose stirring is maintained, so as to obtain a pH of 3.7.

(c) The obtained dispersion is then transferred into a Parr cylinder, where it is kept at 120° C. for 16 hours. This heat treatment, with the Parr cylinder acting as an autoclave, leads to the obtaining of a stable dispersion with respect to settling for a period exceeding 6 months.

1. Aqueous colloidal dispersion, wherein the mean diameter of the colloidal particles is at the most of 6 nm, said dispersion comprising:
(1) at least one compound of a metal M, said metal M being a majority metal within the dispersion, which is chosen from the group constituted by alurnium, zirconium and metals of the periodic table with an atomic number between 22 and 31,
(2) at least one complexing agent having pKs(M) (cologarithm of the constant of dissociation of the complex formed by the complexing agent and the cation of said metal M) of more than 2.

2. Dispersion according to claim 1, characterized in that the colloidal particles have a mean diameter between 2 and 5 nm.

3. Dispersion according to claim 1 or 2, characterized in that the metal M is chosen from aluminium, titanium, iron and zirconium.

4. Dispersion according to one of the preceding claims, characterized in that the complexing agent is chosen from acid-alcohols or polyacid-alcohols, aliphatic amino acids, aliphatic amino polyacids, polyacrylic acids or salts of said compounds.

5. Dispersion according to one of the preceding claims, characterized in that the complexing agent has a pKs of at least 3.

6. Dispersion according to one of the preceding claims, characterized in that it has a pH between 3 and 10.

7. Dispersion according to one of the claims 1 to 6, characterized in that it has a concentration of metal M of at least 0.5 mole/l.

8. Dispersion according to one of the preceding claims, characterized in that the complexing agent level within the suspension, expressed as the number of moles of complexing agent relative to the number of moles of metal M is between 0.1 and 2.

9. Dispersion according to one of the preceding claims, characterized in that the complexing agent level present in the colloids, expressed as a number of moles of complexing agent relative to the number of moles of metal M is between 0.1 and 2.

10. Dispersion according to one of the claims 1 to 9, characterized in that it comprises one or more compounds of one or more additional metallic elements, other than said metal M, chosen from among lanthanides, alumiium and elements of groups IVa, Va, VIa, VIIa, VIII, Ib and IIb of the periodic table, the molar ratio (metal M)/(metal M+other element or elements) strictly exceeding 50%.

11. Dispersion according to one of the claims 1 to 9, characterized in that it comprises a compound of an additional metallic element A chosen from among aluminium and elements of groups IVa, Va, VIa, VIIa, VIII, Ib and IIb of the periodic table, the molar ratio M/(M+A) being 50%.

12. Dispersion according to claim 10 or 11, characterized in that it has a concentration of metal M and of the supplementary element or elements of at least 0.5 mole/l.

13. Dispersion according to any one of the claims 10 to 12, characterized in that the complexing agent level within said dispersion, expressed as a number of moles of complexing agent relative to the number of moles of metal M and said supplementary element or elements is between 0.1 and 2.

14. Dispersion according to any one of the claims 10 to 13, characterized in that the complexing agent level present in the colloids, expressed as a number of moles of complexing agent relative to the number of moles of metal M and said supplementary element or elements is between 0.1 and 2.

15. Process for the preparation of a dispersion according to any one of the claims 1 to 9, comprising the steps consisting of:
(a) forming an aqueous mixture comprising at least one salt of said metal M and at least one complexing agent, with a complexing agent molar level relative to the salt or salts introduced between 0.1 and 3;
(b) adding a base to the formed mixture; and
(c) heating the obtained mixture, which leads to the dispersion.

16. Process for the preparation of a dispersion according to any one of the claims 10 to 14, comprising the steps consisting of:
(a) forming an aqueous mixture comprising at least one salt of said metal M, one or more salts of said additional metallic elements and at least one complexing agent, with a complexing agent molar level relative to the salt or salts introduced between 0.1 and 3;
(b) adding a base to the formed mixture; and
(c) heating the thus obtained mixture, which leads to the dispersion.

17. Process for the preparation of a dispersion according to any one of the claims 10 to 14, characterized in that it has stages consisting of:
(a) forming:
(i) on the one hand an aqueous mixture comprising at least one salt of said metal M and a first complexing agent and
(ii) on the other hand one or more other mixtures, each comprising one or more salts of said supplementary metallic element or elements and a complexing agent identical to or different from that of the aqueous mixture (i),
with a complexing agent molar level relative to the salt or salts introduced between 0.1 and 3;
(b) adding a base to each of the thus formed mixtures, followed by the combining of said mixtures and optionally the adjustment of the pH; and
(c) heating the thus obtained aqueous medium, which leads to the dispersion.

18. Process according to any one of the claims ID to 17, characterized in that in the mixture or mixtures obtained in step (a), the complexing agent molar level relative to the salt or salts introduced is between 0.25 and 2.

21. Process according to any one of the claims 15 to 20, characterized in that the dispersion obtained at the end of step (c) undergoes an ultrafiltration treatment.

22. Process according to any one of the claims 15 to 21, characterized in that the dispersion also undergoes an evaporation concentration stage.

23. Use of a dispersion according to any one of the claims 1 to 14 or a dispersion obtained by the process according to any one of the claims 15 to 22 in catalysis for a transesterification or polycondensation reaction, or for an amidification reaction, in the preparation of polymer films, in a cosmetic composition, or as a reinforcement for a polymer or mineral matrix.
